(19) United States
(12) Patent Application Publication
(10) Pub. No.: US 2022/0222295 A1
(43) Pub. Date: Jul. 14, 2022

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventors: Yuta NAKAMORI, Tokyo (JP); Kengo TOKUCHI, Kanagawa (JP)

(73) Assignee: FUJIFILM Business Innovation Corp., Tokyo (JP)

(21) Appl. No.: 17/389,372

(22) Filed: Jul. 30, 2021

(30) Foreign Application Priority Data
Jan. 12, 2021 (JP) 2021-002973

(51) Int. Cl. G06F 16/638; G06F 16/64; G06F 16/635; G06F 16/687; G06F 3/16

(52) U.S. Cl. CPC G06F 16/638; G06F 16/64; G06F 3/165; G06F 16/687; G06F 16/635

(57) ABSTRACT

An information processing apparatus includes a processor configured to change audio that is reproduced due to manipulation of data, depending on an environment in which the data is manipulated.

### CROSS-REFERENCE TO RELATED APPLICATIONS

This application is based on and claims priority under 35 USC 119 from Japanese Patent Application No. 2021-002973 filed Jan. 12, 2021.

### BACKGROUND

### (i) Technical Field

The present invention relates to an information processing apparatus, a non-transitory computer readable medium storing an information processing program, and an information processing method.

### (ii) Related Art

JP2004-341229A discloses a music content distribution apparatus that distributes music contents to a client terminal by way of a network. The music content distribution apparatus includes a music content selection unit that selects a music content corresponding to the client terminal upon a web content transmission request from the client terminal connected to a web server on the network, and a combination unit that supplies the music content selected by the music content selection unit to the web server in combination with the web content.

JP1996-212258A discloses a work creation support system including a feature information input unit that inputs feature information of a work to be created, an adaptive attribute search unit that, based on an emotional knowledge base that stores one or more output attributes for constituting a work and the feature information of the work input from the feature information input unit, searches for an output attribute for use in the work from the emotional knowledge base, and a synthesis unit that creates a work based on the output attribute searched by the adaptive attribute search unit.

### SUMMARY

There is a technique in which uniform audio is reproduced in association with user's manipulation of data regardless of an individual environment.

Aspects of non-limiting embodiments of the present disclosure relate to an information processing apparatus, a non-transitory computer readable medium storing an information processing program, and an information processing method that can reproduce audio corresponding to an individual environment compared to a case where audio that is reproduced due to manipulation of data is uniform.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to change audio that is reproduced due to manipulation of data, depending on an environment in which the data is manipulated.

### BRIEF DESCRIPTION OF THE DRAWINGS

Exemplary embodiment(s) of the present invention will be described in detail based on the following figures, wherein:

FIG. 1 is a schematic configuration diagram of an information processing system according to an exemplary embodiment of the invention;

FIG. 2 is a schematic block diagram of a server apparatus according to the exemplary embodiment of the invention;

FIG. 3 is a block diagram showing an example of the functional configuration of a storage unit of the server apparatus according to the exemplary embodiment of the invention;

FIG. 4 is an explanatory view showing an example of a structured information table according to the exemplary embodiment of the invention;

FIG. 5 is an explanatory view showing an example of an item information table according to the exemplary embodiment of the invention;

FIG. 6 is an explanatory view showing an example of an audio data table according to the exemplary embodiment of the invention;

FIG. 7 is a schematic block diagram of a user terminal according to the exemplary embodiment of the invention;

FIG. 8 is a block diagram showing an example of the functional configuration of the server apparatus according to the exemplary embodiment of the invention;

FIG. 9 is a flowchart showing an example of processing of audio reproduction of the information processing apparatus according to the exemplary embodiment of the invention; and

FIG. 10 is an explanatory view showing an example of structured information according to the exemplary embodiment of the invention.

### DETAILED DESCRIPTION

Hereinafter, an example of an exemplary embodiment of the present disclosure will be described referring to the drawings. In the respective drawings, identical or equivalent constituent elements and portions are represented by identical reference numerals. The ratio of the dimensions in the respective drawings is exaggerated for convenience of description and is different from the actual ratio in some cases.

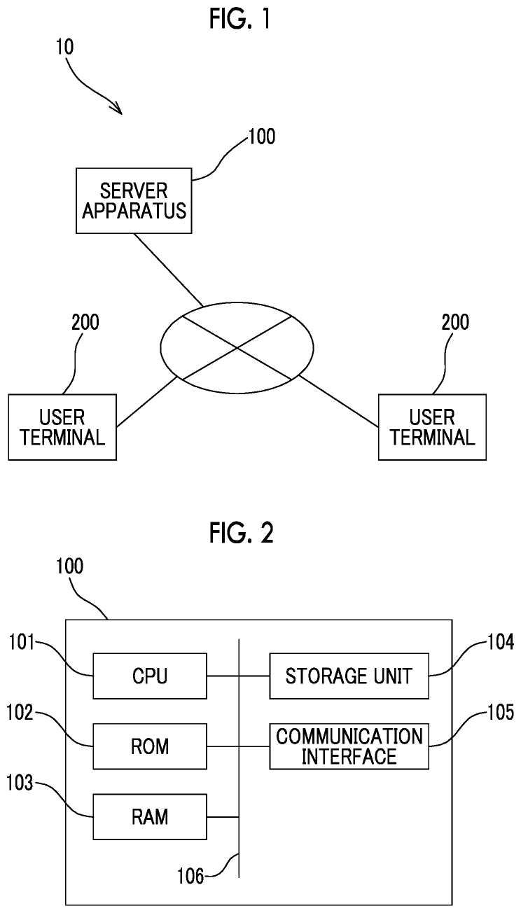

FIG. 1 is a diagram showing the schematic configuration of an information processing system 10 according to the exemplary embodiment. The information processing system 10 according to the exemplary embodiment includes a server apparatus 100 as an example of an information processing apparatus and user terminals 200.

The server apparatus 100 is an apparatus that manages structured information as information in which contents are structured. Although a specific example will be described below, in the exemplary embodiment, the structured information is information in which a relationship between contents is represented pluralistically. In the exemplary embodiment, the structured information that is managed by the server apparatus 100 is information created by each user based on subjective determination. In the exemplary embodiment, the server apparatus 100 has a function of receiving an input regarding creation of structured information from the user terminal 200. Upon structuring contents, not only the user may create structured contents, but also contents may be structured based on a predetermined rule, such as a co-occurrence network.

The user terminal 200 is an apparatus that is connected to the server apparatus 100 through a network, such as the Internet or an intranet, to receive an input from the user with respect to creation of structured information, manipulate data, and reproduce audio. Here, data includes sentences, fictions, figures, video, movie, photos, still images, design drawings, data of presentations, and the like. Data includes data created by an entity other than user, in addition to data created by the user. The manipulation includes opening, viewing or watching, creating data, and the like.

FIG. 2 is a block diagram showing the hardware configuration of the server apparatus 100. The server apparatus 100 is configured using, for example, a computer. The server apparatus 100 may be a cloud server.

As shown in FIG. 2, the server apparatus 100 has a central processing unit (CPU) 101 as an example of a processor, a read only memory (ROM) 102, a random access memory (RAM) 103, a storage unit 104, and a communication interface 105. The respective configurations are connected to each other in a communicable manner via a bus 106.

The CPU 101 is a central arithmetic processing unit and executes various programs or controls the respective units. That is, the CPU 101 reads a program from the ROM 102 or the storage unit 104 and executes the program using the RAM 103 as a work area. The CPU 101 controls the respective configurations described above and executes various kinds of arithmetic processing in compliance with the programs recorded in the ROM 102 or the storage unit 104. In the exemplary embodiment, various programs are stored in the ROM 102 or the storage unit 104.

The ROM 102 stores various programs and various kinds of data. The RAM 103 temporarily stores a program or data as a work area. The storage unit 104 is configured with a hard disk drive (HDD) or a solid state drive (SSD) and stores various programs including an operating system and various kinds of data.

The storage unit 104 of the server apparatus 100 stores various kinds of information regarding the operation of the server apparatus 100. In the exemplary embodiment, the storage unit 104 stores information regarding structured information as an example of information regarding the operation of the server apparatus 100. Information regarding the structured information includes a data structure for generating the structured information.

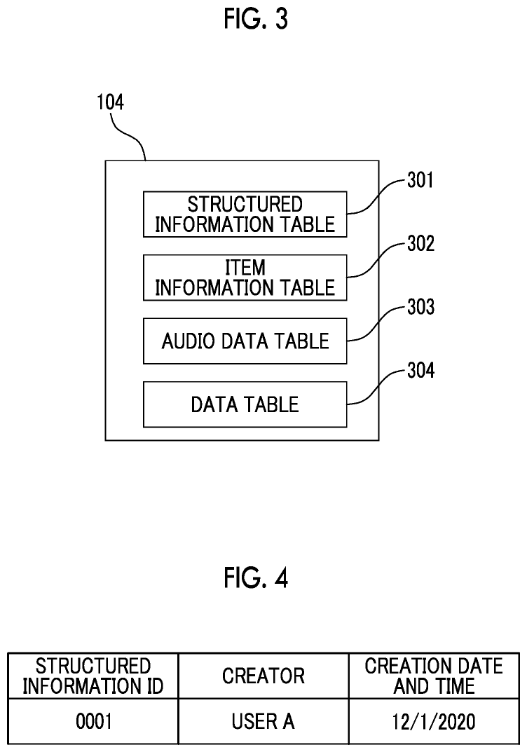

As shown in FIG. 3, the storage unit has storage areas as a structured information table 301, an item information table 302, an audio data table 303, and a data table 304, and stores various kinds of data.

FIG. 4 is a diagram showing an example of the structured information table 301. As shown in FIG. 4, the structured information table 301 has a structured information ID column, a creator column, and a creation date and time column. The structured information ID column is a column that stores an identifier for uniquely identifying structured information. The creator column is a column that stores information regarding the user who creates the structured information. The creation date and time column is a column that stores date and time on which the structured information is created.

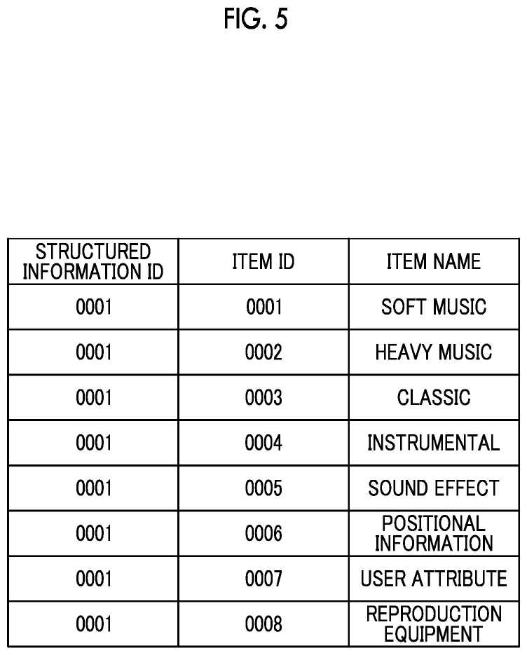

FIG. 5 is a diagram showing an example of the item information table 302. As shown in FIG. 5, the item information table 302 has a structured information ID column, an item ID column, and an item name column. The structured information ID column is a column that stores an identifier for uniquely identifying structured information, and is associated with the structured information ID column in the structured information table 301. The item ID column is a column that stores an identifier for identifying an item. The item is uniquely identified by the identifier of the structured information ID column and the identifier of the item ID column. The item name column is a column that stores a name of the item.

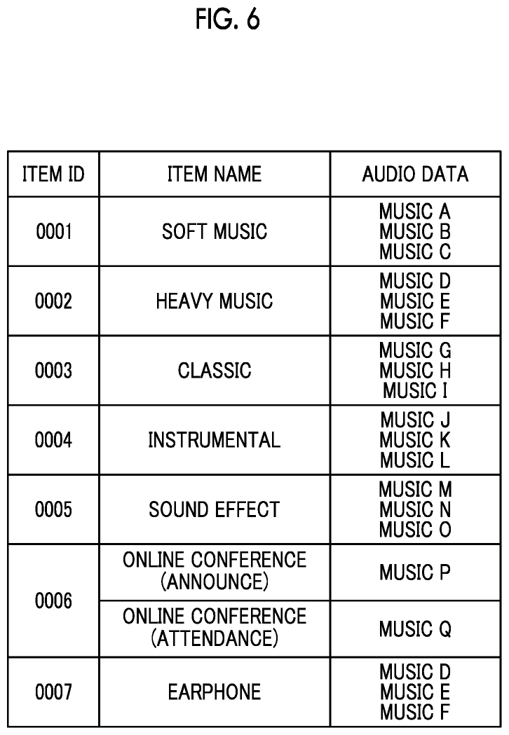

FIG. 6 is a diagram showing an example of the audio data table 303. As shown in FIG. 6, the audio data table 303 has an item ID column, an item name column, and an audio data column. The item ID column is a column that stores an identifier for identifying an item, and is associated with the item ID column in the item information table 302. The audio data column is a column that classifies audio data corresponding to an item name. Specifically, audio data is classified into contents regarding audio, such as “soft music”, “heavy music”, “classic”, “instrumental”, and “sound effect”, and is stored. For example, as shown in FIG. 6, “music A”, “music B”, and “music C” are classified into “soft music”. Such classification is performed by the user inputting audio data from the user terminal 200 and tagging each piece of audio data. The audio data includes audio data in which a volume of voice, a kind of a musical instrument or the number of musical instruments played, or arrangement of music is changed, in addition to different kinds of audio, such as music A or music B. The audio data includes audio that is reproduced as background music (BGM), audio that is reproduced as sound effect, and voice of a human, in addition to music.

The invention is not limited to a case where the user inputs audio data from the user terminal 200 and classifies audio data, and a manager of the information processing system 10 may perform classification or a plurality of pieces of audio data may be prepared and the user may input stored audio data to a learned model learned using the audio data as training data to classify the audio data. The CPU 101 may learn how another user tags identical audio data, or the like, and may tag the audio data. The invention is not limited to a case where each piece of audio data is tagged, and any means may be applied as long as audio data can be classified. For example, a folder may be created for each content and audio data may be saved in each folder. The invention is not limited to a case where audio data is prepared in advance, and the CPU 101 of the server apparatus 100 or a CPU 201 of the user terminal 200 described below may create audio corresponding to an environment in which data is manipulated.

Though not shown, the data table 304 is a table that stores data, such as sentences, figures, video, photos, design drawings, and presentations, which is manipulated by the user.

The communication interface 105 is an interface for communication with other kinds of equipment, such as the user terminal 200, and the standard, such as the Internet, Ethernet (Registered Trademark), FDDI, or Wi-Fi (Registered Trademark), is used.

The server apparatus 100 may be provided with an input unit that includes a pointing device, such as a mouse, and a keyboard and is used to perform various inputs, and a display unit that includes a liquid crystal display and displays various kinds of information.

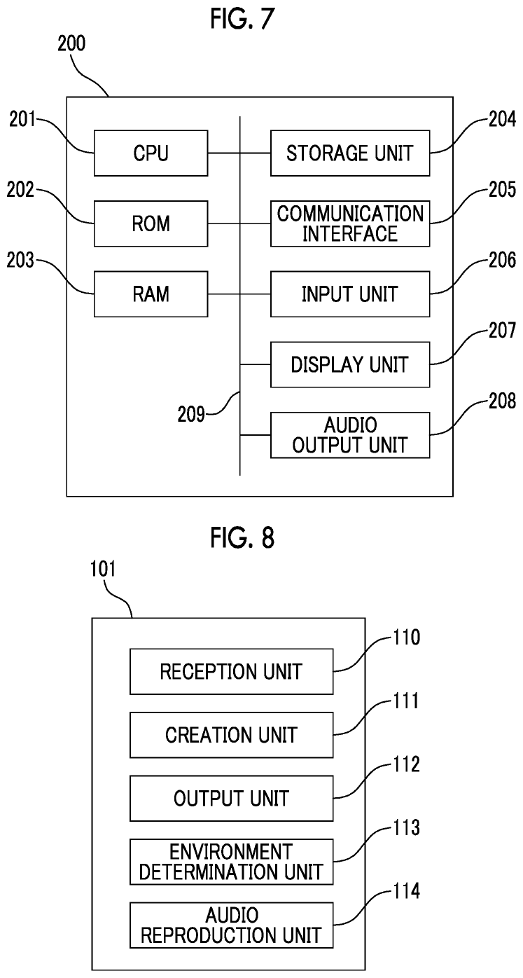

FIG. 7 is a block diagram showing the hardware configuration of the user terminal 200. The user terminal 200 is configured using, for example, a personal computer. The user terminal 200 is not limited to the personal computer, and for example, any kind, such as a smartphone, a tablet terminal, a game machine, or a smart watch, may be used as long as data can be manipulated and audio can be reproduced.

As shown in FIG. 7, the user terminal 200 has a CPU 201, a ROM 202, a RAM 203, a storage unit 204, a communication interface 205, an input unit 206, a display unit 207, and an audio output unit 208. The respective configurations are connected in a communicable manner via a bus 209.

The CPU 201 is a central processing unit and executes various programs or controls the respective units. That is, the CPU 201 reads a program from the ROM 202 or the storage unit 204 and executes the program using the RAM 203 as a work area. The CPU 201 controls the respective configurations described above and executes various kinds of operation processing in compliance with the programs recorded in the ROM 202 or the storage unit 204. In the exemplary embodiment, various programs are stored in the ROM 202 or the storage unit 204.

The ROM 202 stores various programs and various kinds of data. The RAM 203 temporarily stores a program or data as a work area. The storage unit 204 is configured with an HDD or an SSD and stores various programs including an operating system and various kinds of data.

The communication interface 205 is an interface for communication with other kinds of equipment, such as the server apparatus 100, and for example, the standard, such as the Internet, Ethernet (Registered Trademark), FDDI, or Wi-Fi (Registered Trademark), is used.

The input unit 206 includes a pointing device, such as a mouse, and a keyboard and is used to perform various inputs. In the exemplary embodiment, the input unit 206 is used for the user to manipulate data (including opening data, viewing data, reproducing data, creating data, and the like).

The display unit 207 is, for example, a liquid crystal display and displays various kinds of information under the control of the CPU 201. In the exemplary embodiment, as described below, the display unit 207 displays structured information or data manipulated by the user. The display unit 207 may employ a touch panel system to function as the input unit 206.

The audio output unit 208 is, for example, a speaker and output audio under the control of the CPU 201. In the exemplary embodiment, though described below, the audio output unit 208 changes and reproduces audio due to an operation of data corresponding to an environment in which data is manipulated.

The server apparatus 100 realizes various functions using the above-described hardware resources. The functional configuration that is realized by the server apparatus 100 will be described.

FIG. 8 is a diagram showing the functional configuration of the server apparatus 100 according to the exemplary embodiment.

As shown in FIG. 8, the server apparatus 100 has, as the functional configurations, a reception unit 110, a creation unit 111, an output unit 112, an environment determination unit 113, and an audio reproduction unit 114. Each functional configuration is realized by the CPU 101 reading a program stored in the ROM 102 or the storage unit 104 and executing the program.

The reception unit 110 receives an input from the user regarding creation of structured information from the user terminal 200. The input regarding the creation of the structured information includes, for example, various inputs regarding creation of structured information, such as setting of an item as an example of content and connection of items. The items may be created in a form of, for example, files. In the files, various kinds of data, such as text data, image data, and voice data, are stored. The items maybe created in a form of, for example, folders. The server apparatus 100 displays a user interface for creating structured information on a screen of the user terminal 200. The reception unit 110 receives information regarding structured information created on the display unit of the user terminal 200 by a user's operation on the input unit 206 (a key operation of the keyboard or an operation of the mouse), or the like. In addition to reception from the user's key operation of the keyboard, reading of information stored in a hard disk (including not only a hard disk incorporated in a computer but also a hard disk connected to a computer via a network), or the like is included.

The creation unit 111 creates structured information based on the input received by the reception unit 110. For example, edition (including addition, deletion, and the like) of items, reattachment (including addition, deletion, and the like) of relation lines between items, edition of attributes (strength, direction, and the like) of relation lines between items, and the like are performed corresponding to the user's operation received by the reception unit 110.

The output unit 112 outputs the structured information created by the creation unit 111. An output destination of the structured information is the user terminal 200 that receives the input from the user regarding the creation of the structured information. The output unit 112 stores information regarding the structured information created by the creation unit 111 in the storage unit 104.

The environment determination unit 113 determines an environment in which data is manipulated. Here, the environment includes, for example, positional information representing a situation of a position where data is manipulated, type information of an apparatus in which audio is reproduced, and biological information of the user who manipulates data. The environment is not limited to the above-described information, and may be, for example, an atmospheric temperature, weather, date and time, and the like.

In a case where the user terminal 200 is installed at a predetermined location, the positional information representing the situation of the position where data is manipulated is determined based on such information. For example, in a case where the user terminal 200 is a personal computer that is installed in a conference room, determination is made that the location is the conference room. In a case where the user terminal 200 is provided with a positioning system, such as a global positioning system (GPS), positional information obtained from the positioning system is acquired, and determination is made that the location is a home, a park, or the like based on the positional information.

The type information of the apparatus in which audio is reproduced is information regarding, for example, whether the user terminal 200 is a personal computer, a smartphone, or a game machine or a speaker, an earphone, a headphone, or an osseous conduction earphone. The determination of the type information is performed in such a manner that the user stores the type information as structured information in the server apparatus 100. The invention is not limited to a case where the user stores the type information as the structured information in the server apparatus 100, the user terminal 200 and the server apparatus 100 may perform communication, and the server apparatus 100 may acquire the type information from the user terminal 200.

The biological information of the user who manipulates data is, for example, information regarding a heart rate, information regarding a body temperature, information regarding perspiration, information regarding a blood pressure, information regarding a body composition, information regarding a bioelectric potential, information regarding a body weight, information regarding bloodstream, information regarding a brain wave, information regarding a state of an autonomic nerve, information regarding a state of stress known by such information, and information regarding feelings, such as joy, anger, grief, and pleasure. Then, the determination of such biological information is performed in such a manner that an apparatus that measures the biological information is provided in the user terminal 200 and a measurement result is acquired.

The audio reproduction unit 114 changes audio corresponding to the environment in which data is manipulated, via the audio output unit 208 of the user terminal 200. Here, the change of audio includes not only audio that is reproduced corresponding to the environment, but also a case where the environment is changed in the middle and audio is change from the middle. In addition to a case where audio that is reproduced is changed to another audio, a case where a volume is changed based on identical audio or an audio data in which a kind of a musical instrument or the number of musical instruments played, or arrangement of music is changed, is included. In a case where data manipulated includes voice like video, a case where audio is superimposed on the voice or the voice is reduced is included.

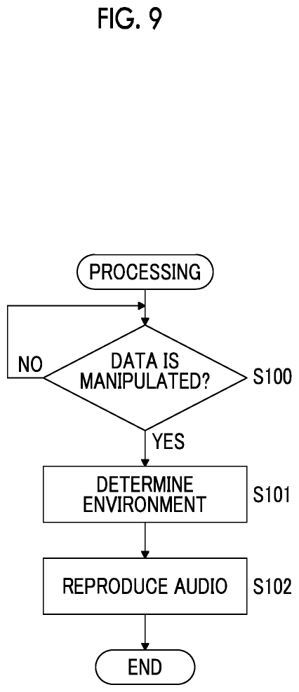

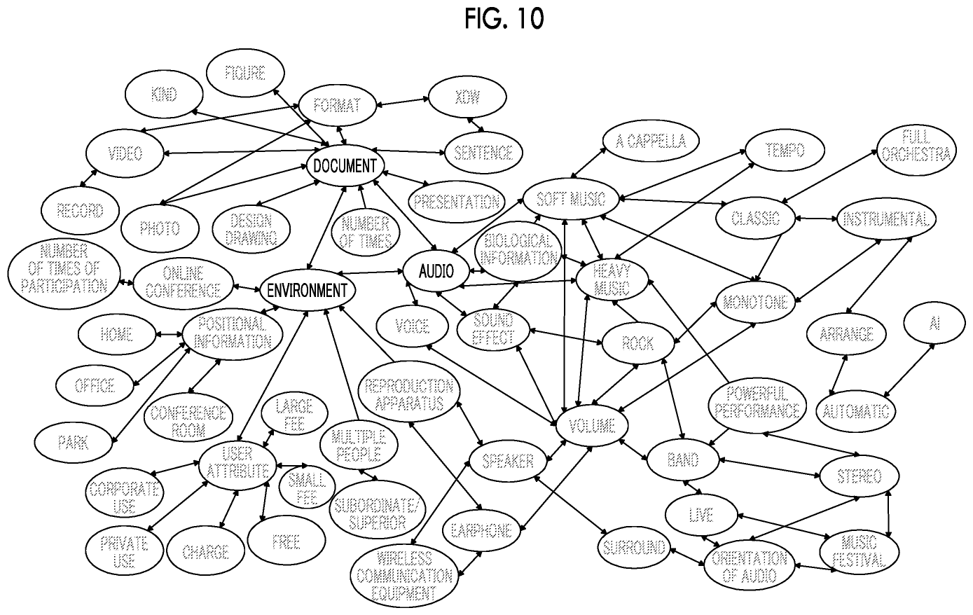

Next, the operations of the server apparatus 100 will be described. An information processing program is executed by the CPU 101, and processing shown in FIG. 9 is executed. Such processing is started as the user manipulates data (including opening data, viewing data, reproducing data, creating data, and the like) by the input unit 206 of the user terminal 200.

FIG. 9 is a flowchart showing an example of the operation of the server apparatus 100.

The server apparatus 100 is not always operated in an order shown in FIG. 9, and may be operated in any order as long as the object can be achieved.

In Step S100 shown in FIG. 9, the CPU 101 determines whether or not data is manipulated by the user. In a case where determination is made that data is manipulated, the CPU 101 progresses to next Step S101, and in a case where determination is not made that data is manipulated, the CPU 101 executes Step S100 again.

In Step S101, the CPU 101 determines an environment in which data is manipulated, based on structured information. Then, the CPU 101 progresses to next Step S102.

In Step S102, the CPU 101 reproduces audio based on the structured information corresponding to the environment determined in Step S101. Then, the processing ends.

The determination of the environment performed in Step S101 is not limited to a case where the determination is performed only once, and includes a case where the determination is performed multiple times using a timer or interruption processing to change audio in association with change in environment.

FIG. 10 is a diagram showing an example of the structured information created by the user. FIG. 10 is a diagram showing an example of the structured information created by the user focusing on items “document”, “audio”, and “environment”. In the structured information, arrows indicate a parent-child relationship of association. Each piece of structured information is subjectively created by the user. In regards to the items, an item as an association destination of a new item may be suggested based on an amount of evaluation performed on association of items related to the new item in the structured information created by an entity other than the user, for example, another user or AI. For example, the server apparatus 100 may suggest an item that has the amount of evaluation exceeding a predetermined threshold value, as the association destination of the new item.

For example, as shown in FIG. 10, the item “document” is associated with “format”, “video”, “still image”, “number of times”, and the like, in addition to “environment” and “audio”. The item “environment” is associated with “online”, “positional information”, “user attribute”, “output equipment”, and the like. The item “audio” is associated with “voice”, “sound effect”, “biological information”, “soft music”, and the like. The items of the structured information are not limited to the items shown in FIG. 10, and other items may be included or all the items shown in FIG. 10 may not be included.

Next, an example of an environment in which data is manipulated and audio that changes corresponding to the environment will be described.

For example, in a case where the environment in which data is manipulated is “online conference” or “Webinar”, audio is changed based on the structured information stored in the server apparatus 100. Specifically, in a case where the environment is “announcement” at “online conference”, “music P” determined in advance by the structured information is reproduced. In a case where the environment is “attendance” at “online conference”, “music Q” determined in advance by the structured information is reproduced as BGM. For a user who announces, since the user is nervous, audio (music P) that is expected to have a relaxation effect is set in advance to be reproduced. For a user who attends the conference, audio (music Q) that is expected to have an effect of preventing concentration from being interrupted is set in advance to be reproduced as BGM. Then, audio is reproduced based on the settings. That is, even though identical data is manipulated, audio that is reproduced is different depending on the environment. In a case where the environment in which data is manipulated is “online conference” or “Webinar”, “number of times of participation” or “comprehension” in “online conference” or “Webinar”, “number of times in which data is manipulated beforehand”, and the like may be further added to the structured information, and predetermined audio may be reproduced for each “number of times of participation” or the like.

For example, in a case where the environment in which data is manipulated is “positional information” representing the situation of the position where data is manipulated, the positional information of the user terminal 200 where data is manipulated is acquired, and in a case where a situation represented by the positional information is a predetermined state, audio is changed depending on the state. Specifically, in a case where the positional information is “home”, music, such as “heavy music” or “rock”, or an increase in “volume” is determined in advance by the structured information, and music (any one of music D, music E, or music F: see FIG. 6) classified by the audio data table 303 is reproduced as BGM based on the setting. In a case where the positional information is “conference room”, “soft music” is determined in advance by the structured information, and music (any one of music A, music B, or music C: see FIG. 6) classified by the audio data table 303 is reproduced as BGM based on the setting.

In a case where the user reaches a specific position, the positional information may be transmitted from the user terminal 200 to the server apparatus 100, and in a case where the server apparatus 100 determines that the user reaches a plurality of predetermined specific positions, special audio may be reproduced.

For example, in a case where the environment in which data is manipulated is a situation surrounding a location where data is manipulated, a noise level surrounding the user terminal 200 where data is manipulated is acquired, and in a case where the noise level is a predetermined state, audio is changed depending on the state. Specifically, a microphone is provided in the user terminal 200, and audio determined in advance by the structured information is reproduced as BGM corresponding to a volume of sound collected by the microphone. With this, it is possible to reproduce audio at a large volume in a case where the volume of sound collected by the microphone is greater than a predetermined threshold value, to reproduce at a small volume in a case where the volume of sound is smaller than the predetermined threshold value, and the like.

For example, in a case where the environment in which data is manipulated is the type information of the apparatus where audio is reproduced, the type information of the user terminal 200 is acquired, and in a case where the type information is a predetermined state, audio is changed depending on the state. Specifically, in a case where “reproduction apparatus” is “earphone”, music (music D, music E, music F: see FIG. 6) classified in advance by the audio data table 303 is reproduced as BGM.

For example, attribute information of the user who manipulates data is acquired, and audio is changed depending on the attribute. Here, the attribute includes information regarding a fee to be paid for data, for example, free and charge or small fee and large fee, the number of users who manipulate data simultaneously, the age and sex of the user, and the like are included. Specifically, in a case where the attribute is information regarding the fee, and in a case where the environment in which data is manipulated is “online conference” or “live”, music is reproduced with luxurious music, such as “full orchestra” or is reproduced with simple music, such as “a cappella” in a case of charged participation or in a case of free participation. In a case where the attributes is the number of people, audio that is reproduced is changed or the volume is changed depending on the number of people.

For example, in a case where the environment in which data is manipulated is the number of times in which data is manipulated, audio is changed depending on the number of times. Specifically, audio that is reproduced is determined in advance by the structured information depending on the number of times in which data is manipulated, and sound is reproduced as BGM depending on the number of times. For example, audio that is reproduced is different between a case where the number of times is once and a case where the number of times is twice. With this, in particular, even in a case where data is data of study, or the like, data is manipulated and changed, such that the user does not get bored. While standard audio is reproduced, in a case where a portion or a field that the user inputs that the user does not understand at a previous time, such as a first time, comes, sound effect is reproduced.

For example, in a case where the environment in which data is manipulated is the biological information of the user who manipulates data, the biological information of the user is acquired, and in a case where the biological information is a predetermined state, audio is changed depending on the state.

Specifically, in a case where “biological information” is information regarding the state of stress of the user, the structured information determines in advance such that, in a case where a stress value obtained by digitizing the state of stress estimated from a pulse, a blood pressure value, a brain wave, or the like is in a predetermined first range, music A is reproduced as BGM, and in a case where the stress value is in a predetermined second range, music B is reproduced as BGM. Then, music A or music B is reproduced as BGM depending on the obtained stress value. For example, in a case where a state in which stress is high is estimated, it is possible to reproduce music that is expected to have a relaxation effect, or the like. Even in a case where many people manipulate identical data, it is possible to change audio that is reproduced, depending on the user.

In a case where “biological information” is a feeling, such as joy, anger, grief, and pleasure, the structured information determines in advance such that, in a case where the feeling of the user estimated from a pulse, a blood pressure value, a brain wave, or the like is a predetermined state, for example, the user feels fear, sound effect or BGM that further enhances fearfulness, or BGM that relaxes fearfulness is reproduced. Then, audio is reproduced depending on the obtained feeling of the user. For example, in particular, in a case where the user manipulates data with plot, such as a game, a fiction, or video, it is possible to change audio in the middle depending on the feeling of the user. Even in a case where many people manipulate identical data, it is possible to change audio that is reproduced, depending on the user.

In a case where “biological information” is a state of consciousness, such as sleepiness of the user, the structured information determines in advance such that, in a case where the state of consciousness of the user estimated from a pulse, a blood pressure value, a brain wave, or the like is a predetermined state, for example, the user feels sleepy, sound effect or BGM that awakes sleepiness is reproduced. Then, audio is reproduced depending on the obtained state of consciousness of the user. For example, even in a case where many people manipulate identical data, such as an online lesson, it is possible to change audio that is reproduced, depending on the user.

In a case where “biological information” is the comprehension of the user, the structured information determines in advance such that, in a case where a state of comprehension of the user estimated from a pulse, a blood pressure value, a brain wave, or the like is a predetermined state, for example, the user feels that the user does not understand, sound effect or BGM is changed. Then, audio is reproduced depending on the obtained comprehension of the user.

The environment in which data is manipulated may be a combination of the above-described environments or a combination of the above-described environments and other environments.

In a case where a plurality of environments overlap each other, either information may be given priority. For example, in a case where the above-described environments are both the positional information and the type information, either information may be given priority. For example, even in a case where the positional information is an environment, such as “conference room”, in which “soft music” is determined in advance, in a case where the type information is “earphone”, music (music D, music E, music F) other than “soft music” may be reproduced. That is, there is a case where audio that is reproduced is different even though a plurality of users manipulate identical data at positions close to each other.

Audio may be changed depending on the above-described environment in which data is manipulated and an attribute of data. Here, the attribute of data includes a type, a size, a filename extension, a format, and the like of data. That is, even though the environment is identical, audio that is reproduced may be changed depending on the attribute of data. For example, in a case where the attribute of data is video, “volume” of sound effect is turned down not to obstruct audio of video, and in a case where the attribute of data is the size, sound effect with small capacity is reproduced to reduce a load of the user terminal 200. Even though data is identical, in a case where software that is operated is different, audio that is reproduced may be changed.

Others

The invention is not limited to the above-described exemplary embodiment, and various modifications or applications can be made without departing from the spirit and scope of the invention.

In the above-described exemplary embodiment, although an aspect that a program is stored (installed) in advance in the ROM 102 or the storage unit 104 has been described, the invention is not limited thereto. The program may be provided in a form of being recorded on a recording medium, such as a compact disk read only memory (CD-ROM), a digital versatile disk read only memory (DVD-ROM), or a universal serial bus (USB) memory. The program may be in a form of being downloaded from an external apparatus via a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above-described exemplary embodiment, although the server apparatus 100 stores the structured information, audio data, and data that is manipulated by the user, and determines the environment, the invention is not limited thereto, and the user terminal 200 may store such information or both the server apparatus 100 and the user terminal 200 may be used.

Although the server apparatus 100 has been described as an example of an information processing apparatus, the invention is not limited thereto. The user terminal 200 may be applied as an example of an information processing apparatus, the server apparatus 100 may not be provided, only the user terminal 200 may store the structured information, audio data, and data that is manipulated by the user, and may determine the environment in which data is manipulated by the user.

In reproducing audio, for example, even in a case where the user designates audio, audio may be reproduced only in a case where a copyright owner authorizes the user to reproduce audio. That is, the authorization of the copyright owner is needed in reproducing audio to prevent infringement of rights. Only in a case where the server apparatus 100, not the user terminal 200, stores audio data, confirmation may be made whether or not the authorization of the copyright owner is obtained. This is because, in a case where the user terminal 200 stores audio data, the user often purchases audio data, and there is no problem with copyright for reproduction; however, in a case where the server apparatus 100 stores audio data, the authorization of the copyright owner is needed for reproduction in the user terminal 200. The authorization of the copyright owner is not needed for all parts of one piece of audio data, and in a case where the authorization of the copyright owner is needed for a portion, the parts other than the portion may be reproduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
change audio that is reproduced due to manipulation of data, depending on an environment in which the data is manipulated.

2. The information processing apparatus according to claim 1, wherein the processor is configured to:
change the audio depending on the environment and an attribute of the data.

3. The information processing apparatus according to claim 1,
wherein the environment and the audio are determined in advance by structured information as information in which contents are structured, and
the structured information is created by a user or an entity other than the user.

4. The information processing apparatus according to claim 2,
wherein the environment and the audio are determined in advance by structured information as information in which contents are structured, and
the structured information is created by a user or an entity other than the user.

5. The information processing apparatus according to claim 1,
wherein the environment is positional information representing a situation of a position where the data is manipulated, and
the processor is configured to:
acquire the positional information, and in a case where the situation of the position represented by the positional information is a predetermined state, change the audio depending on the state.

6. The information processing apparatus according to claim 3,
wherein the environment is positional information representing a situation of a position where the data is manipulated, and
the processor is configured to:
acquire the positional information, and in a case where the situation of the position represented by the positional information is a predetermined state, change the audio depending on the state.

7. The information processing apparatus according to claim 4,
wherein the environment is positional information representing a situation of a position where the data is manipulated, and
the processor is configured to:
acquire the positional information, and in a case where the situation of the position represented by the positional information is a predetermined state, change the audio depending on the state.

8. The information processing apparatus according to claim 1,
wherein the environment is type information of an apparatus in which the audio is reproduced, and
the processor is configured to:
acquire the type information, and in a case where the type information is a predetermined state, change the audio depending on the state.

9. The information processing apparatus according to claim 2,
wherein the environment is type information of an apparatus in which the audio is reproduced, and
the processor is configured to:
acquire the type information, and in a case where the type information is a predetermined state, change the audio depending on the state.

10. The information processing apparatus according to claim 3,
wherein the environment is type information of an apparatus in which the audio is reproduced, and
the processor is configured to:
acquire the type information, and in a case where the type information is a predetermined state, change the audio depending on the state.

11. The information processing apparatus according to claim 4,
wherein the environment is type information of an apparatus in which the audio is reproduced, and
the processor is configured to:
acquire the type information, and in a case where the type information is a predetermined state, change the audio depending on the state.

12. The information processing apparatus according to claim 5,
wherein the environment is type information of an apparatus in which the audio is reproduced, and
the processor is configured to:
acquire the type information, and in a case where the type information is a predetermined state, change the audio depending on the state.

13. The information processing apparatus according to claim 1, wherein the processor is configured to:
change the audio depending on an attribute of a user who manipulates the data.

14. The information processing apparatus according to claim 13,
wherein the attribute includes information regarding a fee that is paid for the data.

15. The information processing apparatus according to claim 1, wherein the processor is configured to:
change the audio depending on the number of times in which the data is manipulated.

16. The information processing apparatus according to claim 1,
wherein the environment is biological information of a user who manipulates the data,
the processor is configured to:
acquire the biological information, and in a case where the biological information is a predetermined state, change audio that is reproduced, depending on the state.

17. The information processing apparatus according to claim 16,
wherein the biological information includes information regarding a state of stress associated with manipulation of the data.

18. The information processing apparatus according to claim 16,
wherein the biological information includes information regarding a feeling associated with manipulation of the data.

19. A non-transitory computer readable medium storing an information processing program that causes a computer to function as the information processing apparatus according to claim 1.

20. An information processing method comprising:
changing audio that is reproduced due to manipulation of data, depending on an environment in which the data is manipulated.
